(19) United States
(12) Patent Application Publication
(10) Pub. No.: US 2024/0329368 A1
(43) Pub. Date: Oct. 3, 2024

(54) OPTICALLY ATHERMAL INFRARED REIMAGING LENS ASSEMBLY

(71) Applicant: RAYTHEON COMPANY, Waltham, MA (US)

(72) Inventors: Matthew Aaron Sinclair, Allen, TX (US); Robert B. Chipper, McKinney, TX (US); Brent L. Sisney, Allen, TX (US)

(21) Appl. No.: 18/129,994

(22) Filed: Apr. 3, 2023

(51) Int. Cl. G02B 13/14; G02B 7/02; G02B 13/00

(52) U.S. Cl. CPC G02B 13/14; G02B 7/028; G02B 13/0005; G02B 13/0095

(57) ABSTRACT

A passive optically athermal infrared reimaging objective lens assembly includes a lens housing fabricated from a single material or materials having similar coefficients of thermal expansion. The lens assembly further includes an imager lens group supported by the lens housing. The imager lens group is positioned within the lens housing toward a scene and including multiple lenses having a positive refractive power. The lens assembly further includes a relay lens group supported lens housing. The relay lens group is positioned behind the imager lens group and including two lenses having a positive refractive power. The lens assembly further includes a cold stop positioned behind the relay lens group and a detector positioned behind the cold stop and configured to detect an image.

### BACKGROUND OF THE DISCLOSURE

### Field of the Disclosure

The present disclosure relates to a lens assembly, and more particularly to an optically athermal infrared reimaging lens assembly that provides a wide field of view (FOV) while being able to operate over large temperature ranges.

### Description of the Related Art

High-resolution imaging lenses are used in many different applications, such as electronic surveillance, photography, cell phones, smart devices, and aerial mapping applications, to name a few. The designs vary depending on many parameters, such as packaging requirements, cost, weight, resolution, vignetting, and environmental conditions. Lens parameters, such as field of view, focal length (EFL), f/#, stop location, back focal length (BFL), are among the most important design features. Families of lens types and their derivatives are often grouped into certain classes using these parameters, ratios of these parameters, or other combinations of them. Two common examples are “telephoto” or “inverse-telephoto” lens assemblies, which depend on the sign of the focal power of lens groups deposed about the stop. In addition, many of these will require a focus capability to compensate changes to object distance, altitude, or other reasons. Some may be required to be athermal (passively temperature compensated) by design choices of materials and their properties, such as linear coefficient of thermal expansion (CTE) and temperature coefficients of refractive index (dn/dT). Alternatively, one may use active athermal focus compensation methods or even both. In addition, vignetting may or may not be allowed.

Additionally, the housing material is also sensitive to thermal change, and should be addressed when considering an athermalized design. Further, boresight retention is a consideration in lens design.

### SUMMARY OF THE DISCLOSURE

One aspect of the present disclosure is directed to a passive optically athermal infrared reimaging objective lens assembly comprising a lens housing fabricated from a single material or materials having similar coefficients of thermal expansion. The lens assembly further comprises an imager lens group supported by the lens housing. The imager lens group is positioned within the lens housing toward a scene and including multiple lenses having a positive refractive power. The lens assembly further comprises a relay lens group supported lens housing. The relay lens group is positioned behind the imager lens group and including two lenses having a positive refractive power. The lens assembly further comprises a cold stop positioned behind the relay lens group and a detector positioned behind the cold stop and configured to detect an image.

Embodiments of the lens assembly further may include configuring the imager lens group to have a first lens embodying a negative meniscus lens, a second lens embodying a positive meniscus lens, a third lens embodying a positive meniscus lens and an optional fourth lens embodying a positive meniscus lens. The first lens may function as a front objective lens configured to have a wide FOV. The relay lens group may include a fifth lens embodying a positive meniscus lens and a sixth lens embodying a positive meniscus lens. The relay lens group may be configured to move within the lens housing to provide an active focus feature for the lens assembly. The relay lens group may include a relay lens mount that is configured support the lenses and configured to linearly ride on rails provided in the lens housing. The relay lens group may be configured to move linearly toward and away from the imager lens group to adjust a focus of the lens assembly. The lens assembly further may include an entrance pupil provided at an object side of the imager lens group. The imager lens group may include an entrance pupil baffle that functions as the entrance pupil. The entrance pupil baffle may be supported by the lens housing and disposed between a first lens and a second lens of the imager lens group. The relay lens group may include an exit pupil provided at a back side of the relay lens group. The lens assembly further may include a baffle supported by the lens housing and disposed in the lens housing between the imager lens group and the relay lens group. The baffle may be configured to prevent stray light from adversely affecting the image. The lens housing may be a cylindrical structure configured to support, surround and protect the imager lens group and the relay lens group. The lens housing may be fabricated from aluminum. The lens assembly further may include a filter disposed between the cold stop and the detector. The imager lens group and the relay lens group may be configured to achieve F-theta distortion mapping.

Another aspect of the present disclosure is directed to a method of detecting an image of a scene with a passive optically athermal reimaging lens assembly. In one embodiment, the method comprises: directing energy through an imager lens group of the lens assembly, the imager lens group being configured to have a positive refractive power and positioned to receive energy along an optical path extending through the lens assembly; directing energy from the imager lens group through to a relay lens group of the lens assembly, the relay lens group being configured to have a positive refractive power and being positioned along the optical path to receive the energy from the imager lens group; and detecting an image from the energy with a detector centered along the optical path and positioned to receive the energy from the relay lens group. A cold stop is positioned between the relay lens group and the detector. The imager lens group and the relay lens group are supported by a lens housing fabricated from a single material or from materials having similar coefficients of thermal expansion.

Embodiments of the method further may include configuring the imager lens group to have a first lens embodying a negative meniscus lens, a second lens embodying a positive meniscus lens, a third lens embodying a positive meniscus lens and an optional fourth lens embodying a positive meniscus lens, and configuring the relay lens group to have a fifth lens embodying a positive meniscus lens and a sixth lens embodying a positive meniscus lens. The method further may include moving the relay lens group within the lens housing to provide an active focus feature for the lens assembly. The relay lens group may include a relay lens mount that is configured support the lenses and configured to linearly ride on rails provided in the lens housing. The relay lens group may be configured to move linearly toward and away from the imager lens group to adjust a focus of the lens assembly. The method further may include positioning an entrance pupil baffle between a first lens and a second lens of the imager lens group. The method further may include positioning a baffle disposed in the lens housing between the imager lens group and the relay lens group. The baffle may be configured to prevent stray light from adversely affecting the image.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the disclosure. In the figures, each identical or nearly identical component that is illustrated in various figures is represented by a like numeral. For purposes of clarity, not every component may be labeled in every figure. In the figures:

FIG. 1 is a cross-sectional view of an optically athermal infrared reimaging lens assembly of an embodiment of the present disclosure;

FIG. 2 is a cross-sectional view of an optically athermal infrared reimaging lens assembly of another embodiment of the present disclosure;

FIG. 3 is a cross-sectional view of an optically athermal infrared reimaging lens assembly of yet another embodiment of the present disclosure; and

FIG. 4 is a view showing the lenses of the optically athermal infrared reimaging lens assembly of an embodiment of the present disclosure without a housing used to secure the lenses in place.

### DETAILED DESCRIPTION

Embodiments of the system of the present disclosure provide an optically athermal infrared reimaging lens assembly having an active or passive focal adjustment, while entirely or nearly entirely in an aluminum barrel that functions as a housing. The lens assembly is configured to provide wide field of view while being able to operate under a range of thermal conditions. Embodiments of the present disclosure may include a system having several lens groups, such as a front group with positive refractive power and a rear group with positive refractive power.

Front stop designs are often associated with simple single element landscape lenses that have moderate field of view, but are fairly slow (f/#>f/10). Other front stop designs, such as some Tessar forms, have been documented for photographic applications in particular. For wide area persistent scanning (WAPS) applications, the design will be more complex with several lens groups working in conjunction to achieve a compact high resolution VIS/NIR design with the front stop being required to minimize the footprint on the front scanning mirror. The particular lens design, lens groups (powers, focal lengths, and materials) combined with a front stop and resulting in a passive athermal performance are improvements over prior compact high resolution lens designs and must be free from the typical vignetting of the simpler Tessar forms.

The modulation transfer function (MTF) of an optical system, such as a camera, specifies how different spatial frequencies are handled by the system. It is used by optical engineers to describe how the optics project light from the object or scene onto a photographic film, detector array, retina, screen, or simply the next item in the optical transmission chain.

Accordingly, the various examples of the lens assembly discussed herein may be incorporated within WAPS imaging systems and other imaging systems designed for platforms with limited available space.

Accordingly, various aspects and examples of the lens assembly discussed herein offer an improved lens design with improved FOV and performance in various environments. While discussed with reference to an aerial imaging system for the purpose of explanation, in various other examples the imaging system may be designed for a ground platform, a maritime platform, a space platform, or any other mobile platform or vehicle.

The boresight retention of the lenses can include active and passive focus. Although multiple opto-mechanical passive athermal designs may achieve a better MTF performance, dissimilar materials still run the risk of decentering the lenses. In some embodiments, an active focus can be employed, and in other embodiments, a passive focus is used.

A small window in front of the lens pushes the entrance pupil towards the front of the lens. This is best done by a reimaging optical design. There also may be a requirement to have a convex first lens. This requirement pushes the entrance pupil inside of the front lens where a baffle can be conveniently placed as a Lyot stop for stray light.

Optical systems are provided to achieve a variety of fields of view (FOV). Presently known optical systems have limited fields of view. Examples of such systems are systems incorporating Schmidt and Schmidt-Cassegrain lenses. The optical system of embodiments of the present disclosure is designed to achieve a wider field of view, while providing improved performance under varied thermal conditions. For example, some embodiments of the present disclosure are designed to achieve a FOV greater than 120-degrees, e.g., a 130-degree FOV.

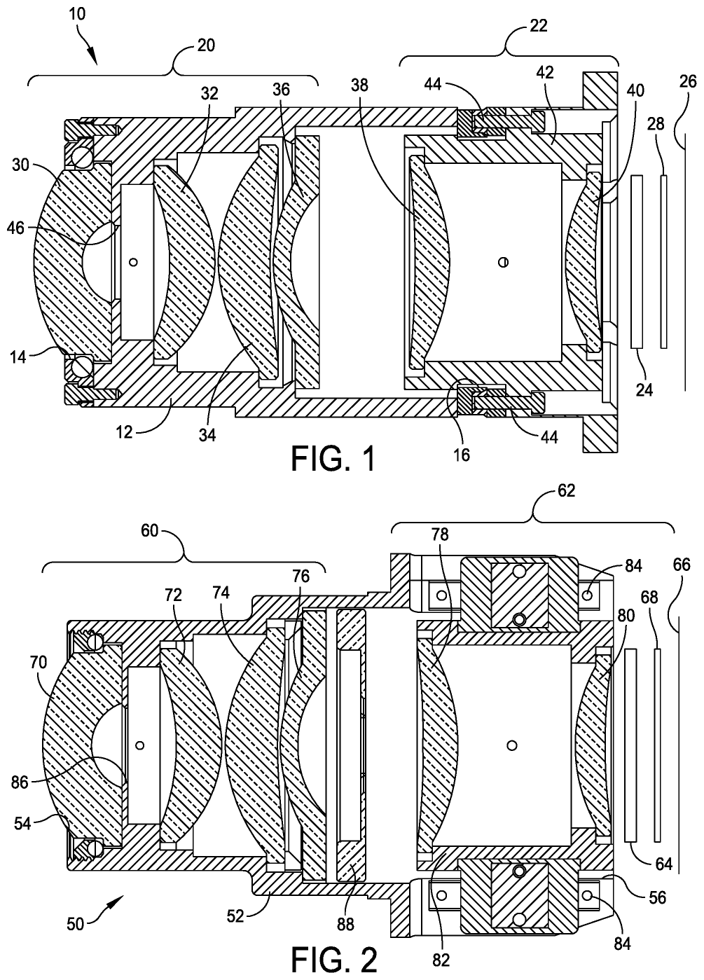

Referring to the drawings, and more particularly to FIG. 1, an optically athermal infrared reimaging lens assembly, referred to herein as a lens assembly, is generally indicated at 10. In the shown embodiment, the lens assembly 10 is configured to have an optically passive focus functionality. As shown, the lens assembly 10 includes a lens housing 12, which is configured to support the lenses and other components of the lens assembly. As shown, the lens housing 12 includes a generally cylindrical body that is designed to accommodate the particular lens arrangement. The lens housing 12 supports, surrounds and protects the components of the lens assembly, and may be fabricated from aluminum, for example. Other suitable materials may also be employed. The lens housing 12 may include an entrance window 14 through which an aperture stop and a lens group receive the energy from a scene. The lens housing 12 further may include an exit window 16 through which light carrying an image travels. Although described as a unitary structure, the lens housing may include several housing components.

The lens assembly 10 further includes a first lens group, referred to herein as an imager lens group, together indicated at 20, and a second lens group, referred to herein as a relay lens group, together indicated at 22. The imager lens group 20 is positioned forward within the lens housing 12 of the lens assembly 10 toward the scene, with the relay lens 22 group being positioned behind the imager lens group. As shown, the imager lens group 20 and the relay lens group 22 are supported by the lens housing 12. The interior of the lens housing 12 is formed to secure the lenses of the imager lens group 20 and the lenses of the relay lens group 22. The lens assembly 10 further includes a cold stop 24 positioned behind the relay lens group. A cold stop is a device to protect an object from unwanted heating by thermal radiation or light. Cold stops are used in infrared optical devices for military applications, for example, and are provided to protect infrared sensors from stray infrared radiation.

The lens assembly 10 further includes a detector 26, such as a focal plane array, with a filter 28 disposed between the cold stop 24 and the detector. The detector 26 is provided to detect an image from the light that travels through the lens assembly 10. In one embodiment, the detector 26 is an image sensor having an array of light-sensitive pixels at the focal plane of the lens assembly 10. Although focal plane arrays are used for imaging purposes, the focal plane array can also be used for non-imaging purposes, such as spectrometry, light detection and ranging (LIDAR), and wave-front sensing.

As shown, the imager lens group 20 of the lens assembly 10 includes multiple lenses having a positive refractive power. In some embodiments, the imager lens group includes three lenses. In some other embodiments, the imager lens group 20 may include less or more than three lenses. In one embodiment, the imager lens group 20 includes four lenses, including a first or front objective lens 30 embodying a negative meniscus lens, a second lens 32 embodying a positive meniscus lens, a third lens 34 embodying a positive meniscus lens and fourth lens 36 embodying a weak positive (almost negative) meniscus lens. In other embodiments, the fourth lens could be optional, or could include a weak negative meniscus lens. As known in optics, a positive meniscus lens is a convex-concave lens thicker at its center than at its edges. A positive meniscus lens is used to minimize spherical aberration. When used in combination with other lenses, a positive meniscus lens will shorten the focal length, and increase the numerical aperture (NA) of the lens assembly. A negative meniscus lens is a convex-concave lens that is thinner at its center than at its edges. A negative meniscus lens increases a divergence of a beam without introducing any significant spherical aberration. When used in combination with other lenses, a negative meniscus lens increases the focal length, and decreases the NA of the system.

In one embodiment, the fourth lens 36 has a diffractive optical element (DOE) on a surface of the lens. The DOE aids in correcting lateral (transverse) chromatic color over temperature.

The front objective lens 30 of the imager lens group 20 is configured to have a wide FOV, which is the extent of the observable space viewed by the lens assembly 10 at any given moment. The FOV is dependent on a focal length of the lens assembly 10, which is a measure of how strongly the system converges or diverges light. A positive focal length indicates that the lens assembly converges light, while a negative focal length indicates that the lens assembly diverges light. The relatively short effective focal length achieved by the combined power of the imager lens group 20 enables the lens assembly to achieve a wide field of view, which will be described below. When obtaining images from great distances, a longer focal length provides a higher magnification and smaller FOV, while a shorter focal length provides a lower magnification and a larger FOV. The focal length can be selected to provide a FOV ranging from 40 degrees to 150 degrees.

The relay lens group 22 of the lens assembly 10 includes two lenses having a positive refractive power. In one embodiment, the relay lens group 22 includes a fifth lens 38 embodying a positive meniscus lens and a sixth lens 40 embodying a positive meniscus lens. With this embodiment of the lens assembly 10, the relay lens group 22 is configured to be supported by the lens housing 12, to provide a passive focus for the lens assembly, meaning that the relay lens group is fixed with respect to the lens housing and the positioning of the imager lens group 20 disposed within the lens housing. Specifically, the relay lens group 22 includes a relay lens mount 42 that is configured to support the fifth lens 38 and the sixth lens 40. The relay lens mount 42 includes a generally cylindrical body that is sized to fit within the lens housing 12 adjacent the exit window 16 of the lens housing. The relay lens mount 42 is secured to the lens housing 12 by fasteners, each indicated at 44, such as machine screw fasteners.

In one embodiment, the sixth lens 40 has a DOE on a surface of the lens. The DOE aids in correcting longitudinal (axial) chromatic color.

In some embodiments, the lens housing 12 and the relay lens mount 42 are fabricated from the same or single material, e.g., aluminum, or from materials having similar, e.g., near matching or within a close range, coefficients of thermal expansion.

The imager lens group 20 of the lens assembly 10 includes an entrance pupil provided at a front or object side of the imager lens group. In one embodiment, the entrance pupil can be located between the first lens 30 and the second lens 32 of the imager lens group 20. In another embodiment, the entrance pupil is in front of the first lens 30 of the imager lens group 20, and would be external to the lens assembly 10. In the shown embodiment, an entrance pupil baffle 46, which defines the location of the entrance pupil, is provided between the first lens 30 and the second lens 32 of the imager lens group 20. The entrance pupil could be configured to define a Lyot stop. As shown, the entrance pupil baffle 46 is formed by the lens housing 12.

The relay lens group 22 includes an exit pupil provided at a back or image side of the relay lens group. The exit pupil is a virtual aperture of the lens assembly 10 and located between the cold stop 24 and the detector 26.

Referring to FIG. 2, an optically athermal infrared reimaging lens assembly is generally indicated at 50. In the shown embodiment, the lens assembly 50 is configured to have an active focus functionality. The lens assembly 50 is similar in construction to lens assembly 10, with differences noted below. As shown, the lens assembly 50 includes a lens housing 52, which is configured to support the lenses and other components of the lens assembly. As with lens housing 12, the lens housing 52 supports, surrounds and protects the components of the lens assembly 50, and may be fabricated from aluminum, for example. The lens housing 52 may include an entrance window 54 through which an aperture stop and a lens group receive the energy from the scene. The lens housing 52 further may include an exit window 56 through which light carrying an image travels.

The lens assembly 50 further includes a first or imager lens group, together indicated at 60, and a second or relay lens group, together indicated at 62. The imager lens group 60 is positioned forward within the lens housing 52 of the lens assembly 50 toward the scene, with the relay lens group 62 being positioned behind the imager lens group. The lens assembly 50 further includes a cold stop 64 positioned behind the relay lens group 62. The lens assembly 50 further includes a detector 66, e.g., a focal plane array, with a filter 68 disposed between the cold stop 64 and the detector. The detector 66 is provided to detect an image from the light that travels through the lens assembly 50.

The imager lens group 60 of the lens assembly 50 includes multiple lenses having a positive refractive power. In some embodiments, the imager lens group 60 includes three lenses. In some embodiments, the imager lens group 60 may include less or more than three lenses. In the shown embodiment, the imager lens group 60 includes four lenses, including a first or front objective lens 70 embodying a negative meniscus lens, a second lens 72 embodying a positive meniscus lens, a third lens 74 embodying a positive meniscus lens and fourth lens 76 embodying a weak positive (almost negative) meniscus lens. In other embodiments, the fourth lens could be optional or could include a weak negative meniscus lens. The front objective lens 70 of the imager lens group 60 is configured to have a wide FOV.

In one embodiment, the fourth lens 76 has a DOE on a surface of the lens. The DOE aids in correcting lateral (transverse) chromatic color over temperature.

The relay lens group 62 of the lens assembly 50 includes two lenses having a positive refractive power. In one embodiment, the relay lens group 62 includes a fifth lens 78 embodying a positive meniscus lens and a sixth lens 80 embodying a positive meniscus lens. With this embodiment of the lens assembly 50, the relay lens group 62 is configured to move within the lens housing 52, which provides an active focus feature for the lens assembly, meaning that the relay lens group is configured to move linearly with respect to the lens housing and the positioning of the imager lens group 60 disposed within the lens housing to adjust a focus of the lens assembly. The movement of the relay lens mount 82 with respect to the lens housing 52 provides an active focus feature to correct one-time assembly use irregularities and/or focus away from infinity. Specifically, the relay lens group 62 includes a relay lens mount 82 that is configured support the fifth lens 78 and the sixth lens 80 and configured to linearly ride on rails, each indicated at 84, provided in the lens housing. The relay lens mount 82 includes a generally cylindrical body that is sized to fit within the lens housing 52 adjacent the exit window 56 of the lens housing.

In one embodiment, the sixth lens 80 has a DOE on a surface of the lens. The DOE aids in correcting longitudinal (axial) chromatic color.

In some embodiments, the lens housing 52 and the relay lens mount 82 are fabricated from the same or single material, e.g., aluminum, or from materials having similar, e.g., near matching or within a close range, coefficients of thermal expansion.

The arrangement is such that the relay lens group 62 is capable of moving linearly toward and away from the imager lens group 60 to adjust a focus of the lens assembly 50. In one embodiment, a controller or some other type of control system is provided to control a motor or some other type of mechanism used to move the relay lens mount 82 within the lens housing 52. In another embodiment, the movement of the relay lens mount 82 with respect to the lens housing 52 can be manual and set in a fixed position by a suitable device, such as a set screw.

The imager lens group 60 of the lens assembly 50 includes an entrance pupil provided at a front or object side of the imager lens group. In one embodiment, the entrance pupil can be located between the first lens 70 and the second lens 72 of the imager lens group 60. In another embodiment, the entrance pupil is in front of the first lens 70 of the imager lens group 60, and would be external to the lens assembly 50. In the shown embodiment, an entrance pupil baffle 86 is provided between the first lens 70 and the second lens 72 of the imager lens group 60. As shown, the entrance pupil baffle 86 is formed by the lens housing 52.

The relay lens group 62 of the lens assembly 50 includes an exit pupil provided at a back or image side of the relay lens group. The exit pupil is a virtual aperture of the lens assembly 50 and located between the cold stop 64, which defines the exit pupil, and the detector 66.

The lens assembly 50 further includes a baffle 88 disposed in the lens housing 52 between the imager lens group 60 and the relay lens group 62. In one embodiment, the baffle 88 is an opto-mechanical device that is designed to block light from a source into the front of the lens assembly 50 and reaching the detector 66 as unwanted light. The baffle 88 prevents stray light from adversely affecting the image as seen by the detector 66.

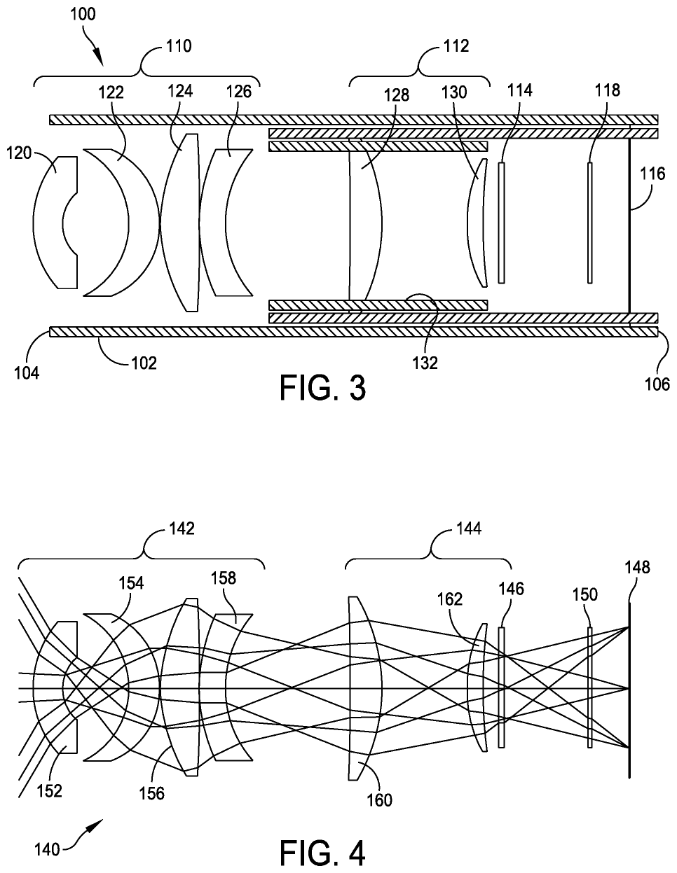

Referring to FIG. 3, an optically athermal infrared reimaging lens assembly is generally indicated at 100. In the shown embodiment, the lens assembly 100 is configured to have a mechanically passive focus functionality. The lens assembly 100 is similar in construction to lens assemblies 10, 50, with differences noted below. As shown, the lens assembly 100 includes a lens housing 102, which is configured to support the lenses and other components of the lens assembly. As shown, the lens housing 102 supports, surrounds and protects the components of the lens assembly 100, and may be fabricated from aluminum, for example. The lens housing 102 may include an entrance window 104 through which an aperture stop and a lens group receive the energy from the scene. The lens housing 102 further may include an exit window 106 through which light carrying an image travels.

The lens assembly 100 further includes a first or imager lens group, together indicated at 110, and a second or relay lens group, together indicated at 112. The imager lens group 110 is positioned forward within the lens housing 102 of the lens assembly 100 toward the scene, with the relay lens group 112 being positioned behind the imager lens group. The lens assembly 100 further includes a cold stop 114 positioned behind the relay lens group 112. The lens assembly further includes a detector 116, such as a focal plane array, with a filter 118 disposed between the cold stop 114 and the detector. The detector 116 is provided to detect an image from the light that travels through the lens assembly 100. As shown, with lens assembly 100, the cold stop 114, the detector 116 and the filter 118 are supported by the lens housing 102.

The imager lens group 110 of the lens assembly 100 includes multiple lenses having a positive refractive power. In some embodiments, the imager lens group 110 includes three lenses. In some other embodiments, the imager lens group 110 may include less or more than three lenses. In one embodiment, the imager lens group 110 includes four lenses, including a first or front objective lens 120 embodying a negative meniscus lens, a second lens 122 embodying a positive meniscus lens, a third lens 124 embodying a positive meniscus lens and fourth lens 126 embodying a weak positive (almost negative) meniscus lens. In other embodiments, the fourth lens could be optional, or could include a weak negative meniscus lens. The front objective lens 120 of the imager lens group 110 is configured to have a wide FOV.

In one embodiment, the fourth lens 126 has a DOE on a surface of the lens. The DOE aids in correcting lateral (transverse) chromatic color over temperature.

The relay lens group 112 of the lens assembly 100 includes two lenses having a positive refractive power. In one embodiment, the relay lens group 112 includes a fifth lens 128 embodying a positive meniscus lens and a sixth lens 130 embodying a positive meniscus lens. With this embodiment of the lens assembly 100, the relay lens group 112 is configured to move within the lens housing 102, which provides a mechanically passive focus feature for the lens assembly. The movement of the relay lens mount 82 with respect to the lens housing 52 provides an active focus feature to correct one-time assembly use irregularities or focus away from infinity. Specifically, the relay lens group 112 includes a relay lens mount 132 in the form of a cylindrical tube, which is disposed within the cylindrical lens housing 102. The relay lens mount 132 is configured support the fifth lens 128 and the sixth lens 130 and configured to move linearly within the lens housing 102. The arrangement is such that the relay lens group 112 is capable of mechanically moving linearly toward and away from the imager lens group 110 to adjust a focus of the lens assembly 100.

In one embodiment, the sixth lens 130 has a DOE on a surface of the lens. The DOE aids in correcting longitudinal (axial) chromatic color over temperature.

In some embodiments, the lens housing 102 and the relay lens mount 132 are fabricated from the same or single material, e.g., aluminum, or from materials having similar, e.g., near matching or within a close range, coefficients of thermal expansion.

The arrangement is such that the relay lens group 112 is capable of moving linearly toward and away from the imager lens group 110 to adjust a focus of the lens assembly 100. As shown, the relay lens mount 132 is positioned to slide within the lens housing 102. In one embodiment, a controller or some other type of control system is provided to control a motor or some other type of mechanism used to move or slide the relay lens mount 132 within the lens housing 102. In another embodiment, the movement of the relay lens mount 82 with respect to the lens housing 52 can be manual and set in a fixed position by a suitable device, such as a set screw.

The imager lens group 110 of the lens assembly 100 includes an entrance pupil provided at a front or object side of the imager lens group. In one embodiment, the entrance pupil can be located between the first lens 120 and the second lens 122 of the imager lens group 110. In another embodiment, the entrance pupil is in front of the first lens 120 of the imager lens group 110, and would be external to the lens assembly 100. Although not shown, the lens assembly can be configured to include an entrance pupil baffle, which defines the location of the entrance pupil, between the first lens 120 and the second lens 122 of the imager lens group 112.

The relay lens group 112 includes an exit pupil provided at a back or image side of the relay lens group. The exit pupil is a virtual aperture of the lens assembly 100 and located between the cold stop 114, which defines the exit pupil, and the detector 116.

In some embodiments, the lenses disclosed herein can be fabricated from a variety of materials. In one example, the imager lens group includes a front objective lens fabricated from zinc sulfide (ZnS), a second lens fabricated from infrared chalcogenide glass 26 (IRG26), a third lens fabricated from IRG26, and a fourth lens fabricated germanium, and the relay lens group includes a fifth lens fabricated from infrared chalcogenide glass 24 (IRG24), and a sixth lens fabricated from IRG24.

The front lens of the imager lens group of the lens assembly can be concave, with the entrance pupil located to the left (object side) of the front lens. Reference can be made to front lenses 30, 70, 120 of imager lens groups 20, 60, 110 of lens assemblies 10, 50, 100, respectively. Other configurations may be contemplated.

Referring to FIG. 4, a lens assembly, generally indicated at 140, is shown without a lens housing. As shown, the lens assembly 140 includes an imager lens group, together indicated at 142, and a relay lens group, together indicated at 144. The lens assembly 140 further includes a cold stop 146 positioned behind the relay lens group 144. The lens assembly 140 further includes a detector 148, such as a focal plane array, with a filter 150 disposed between the cold stop 146 and the detector. The imager lens group 142 includes multiple lenses having a positive refractive power. In one embodiment, the imager lens group 142 includes a front objective lens 152 embodying a negative meniscus lens, a second lens 154 embodying a positive meniscus lens, a third lens 156 embodying a positive meniscus lens and fourth lens 158 embodying a weak positive (almost negative) meniscus lens. The front objective lens 152 of the imager lens group 142 is configured to have a wide FOV. As noted above, the imager lens group 142 may include any number of lenses. The relay lens group 144 includes two lenses having a positive refractive power. The relay lens group 144 includes a fifth lens 160 embodying a positive meniscus lens and a sixth lens 162 embodying a positive meniscus lens.

As shown, light traveling through the lens assembly 140 produces an extremely wide FOV. In one example, the FOV of the front aperture of the lens assembly 140 is 130 degrees. As shown, light travels through the imager lens group 142, the relay lens group 144, the cold stop 146, and the filter 148 before being received by the detector 148.

It should be observed that the imager lens group and the relay lens group are configured to achieve F-theta distortion mapping. Specifically, for a multi-element lens assembly, such as lens assemblies 10, 50, 100, 140, distortion may be positive or negative, but it may not be linear across the image. The level of distortion may change as the working distance changes and is dependent on wavelength. Some lenses that are engineered to exhibit very low levels of distortion may have both positive and negative distortion. Another type of distortion is F-theta lens distortion. F-theta lenses may be designed to produce a certain amount of distortion so that an image height is proportional to a field angle of theta (0). The imager lens group and the relay lens group of embodiments of the lens assemblies described herein are configured address this type of distortion.

Traditional wide field of view systems default to inverse telephoto (retro-focus), fisheye, angulon, and double Gauss lens designs. All of these designs have a large footprint on the first lens. This translates into a larger aperture needed to image out of or a bigger window to image through. These designs have a buried entrance pupil often located after the aperture stop. This leads to straylight issues when imaging around bright objects. Embodiments of the lens assemblies disclosed herein relay the entrance pupil location towards the front of the lens where it is baffled in front of the cold stop (aperture stop). The intermediate image plane baffle provides additional baffling at a location which controls field of view and will not vignette any desired fields transmission. The relayed entrance pupil significantly reduces the footprint on the lens. The combination of IR materials, DOEs, and single lens housing material make the lens optically athermal. An optically athermal lens design allows for tight boresight retention since there are no moving lenses or dissimilar housing materials. Various features of the optical design of some embodiments disclosed herein, e.g., passive optical focus athermalization, achieve many additional advantages, such as fewer parts, no moving components/parts (such as motors), and provide significantly better boresight control over a desired temperature range.

Thus, it should be observed that embodiments of the optically athermal infrared reimaging lens assembly produces a wide field of view while having optically passive athermal features.

In some embodiments, the lens assembly is configured to be optically passive to maximize imaging performance over temperature. In this embodiment, the lens assembly is configured to minimize cost of the assembly.

In some embodiments, the lens assembly is configured to be optically active to enable the focus of the lens assembly to be adjusted.

In some embodiments, the lens assembly includes a forward entrance pupil to minimize an exit window.

In some embodiments, an entrance pupil baffle, e.g., a Lyot stop, may be provided to minimize stray light. In one embodiment, the entrance pupil baffle is positioned adjacent to a front entrance pupil and a baffle is positioned adjacent to an intermediate image plane.

In some embodiments, the lens assembly includes a detector having improved imaging resulting from smaller pixel pitch with greater pixels.

In some embodiments, the lens assembly is configured with a minimized optical window by reimaging the entrance pupil to the front of the lens assembly.

Aspects of the present disclosure can be directed to reimaging visible and invisible light, including infrared. The lens assemblies disclosed herein are particularly configured to reimage infrared images, but can be applied to visible light as well.

It is to be appreciated that embodiments of the systems and apparatuses discussed herein are not limited in application to the details of construction and the arrangement of components set forth in the following description or illustrated in the accompanying drawings. The systems and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having described above several aspects of at least one example, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

What is claimed is:

1. A passive optically athermal infrared reimaging objective lens assembly comprising:
a lens housing fabricated from a single material or materials having similar coefficients of thermal expansion;
an imager lens group supported by the lens housing, the imager lens group being positioned within the lens housing toward a scene and including multiple lenses having a positive refractive power;
a relay lens group supported lens housing, the relay lens group being positioned behind the imager lens group and including two lenses having a positive refractive power;
a cold stop positioned behind the relay lens group; and
a detector positioned behind the cold stop and configured to detect an image.

2. The lens assembly of claim 1, wherein the imager lens group includes a first lens embodying a negative meniscus lens, a second lens embodying a positive meniscus lens, a third lens embodying a positive meniscus lens and an optional fourth lens embodying a positive meniscus lens.

3. The lens assembly of claim 2, wherein the first lens functions as a front objective lens configured to have a wide FOV.

4. The lens assembly of claim 2, wherein the relay lens group includes a fifth lens embodying a positive meniscus lens and a sixth lens embodying a positive meniscus lens.

5. The lens assembly of claim 1, wherein the relay lens group is configured to move within the lens housing to provide an active focus feature for the lens assembly.

6. The lens assembly of claim 5, wherein the relay lens group includes a relay lens mount that is configured support the lenses and configured to linearly ride on rails provided in the lens housing, the relay lens group being configured to move linearly toward and away from the imager lens group to adjust a focus of the lens assembly.

7. The lens assembly of claim 1, further comprising an entrance pupil provided at an object side of the imager lens group.

8. The lens assembly of claim 7, wherein the imager lens group includes an entrance pupil baffle that functions as the entrance pupil, the entrance pupil baffle being supported by the lens housing and disposed between a first lens and a second lens of the imager lens group.

9. The lens assembly of claim 1, wherein the relay lens group includes an exit pupil provided at a back side of the relay lens group.

10. The lens assembly of claim 1, further comprising a baffle supported by the lens housing and disposed in the lens housing between the imager lens group and the relay lens group, the baffle being configured to prevent stray light from adversely affecting the image.

11. The lens assembly of claim 1, wherein the lens housing is a cylindrical structure configured to support, surround and protect the imager lens group and the relay lens group.

12. The lens assembly of claim 11, wherein the lens housing is fabricated from aluminum.

13. The lens assembly of claim 1, further comprising a filter disposed between the cold stop and the detector.

14. The lens assembly of claim 1, wherein the imager lens group and the relay lens group are configured to achieve F-theta distortion mapping.

15. A method of detecting an image of a scene with a passive optically athermal reimaging lens assembly, the method comprising:
directing energy through an imager lens group of the lens assembly, the imager lens group being configured to have a positive refractive power and positioned to receive visible light along an optical path extending through the lens assembly;
directing energy from the imager lens group through to a relay lens group of the lens assembly, the relay lens group being configured to have a positive refractive power and being positioned along the optical path to receive the energy from the imager lens group; and
detecting an image from the energy with a detector centered along the optical path and positioned to receive the energy from the relay lens group,
wherein the imager lens group and the relay lens group are supported by a lens housing fabricated from a single material or from materials having similar coefficients of thermal expansion.

16. The method of claim 15, wherein the imager lens group includes a first lens embodying a negative meniscus lens, a second lens embodying a positive meniscus lens, a third lens embodying a positive meniscus lens and an optional fourth lens embodying a positive meniscus lens, and the relay lens group includes a fifth lens embodying a positive meniscus lens and a sixth lens embodying a positive meniscus lens.

17. The method of claim 15, further comprising moving the relay lens group within the lens housing to provide an active focus feature for the lens assembly.

18. The method of claim 17, wherein the relay lens group includes a relay lens mount that is configured support the lenses and configured to linearly ride on rails provided in the lens housing, the relay lens group being configured to move linearly toward and away from the imager lens group to adjust a focus of the lens assembly.

19. The method of claim 15, further comprising positioning an entrance pupil baffle between a first lens and a second lens of the imager lens group.

20. The method of claim 1, further comprising positioning a baffle disposed in the lens housing between the imager lens group and the relay lens group, the baffle being configured to prevent stray light from adversely affecting the image.
